(19) United States
(12) Patent Application Publication
(10) Pub. No.: US 2026/0236205 A1
(43) Pub. Date: Aug. 13, 2026

(54) AUTHENTICATION SYSTEM, CLOUD PRINT SERVICE SYSTEM, AND NON-TRANSITORY COMPUTER READABLE MEDIUM

(71) Applicant: FUJIFILM Business Innovation Corp., Tokyo (JP)

(72) Inventor: Takashi KURIHARA, Kanagawa (JP)

(73) Assignee: FUJIFILM Business Innovation Corp., Tokyo (JP)

(21) Appl. No.: 19/307,534

(22) Filed: Aug. 22, 2025

(30) Foreign Application Priority Data
Feb. 12, 2025 (JP) 2025-020934

(51) Int. Cl. G06F 3/12; H04L 9/40

(52) U.S. Cl. CPC G06F 3/1238; G06F 3/1222; G06F 3/1288; H04L 63/08

(57) ABSTRACT

An authentication system includes a processor configured to: perform, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and transmit code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.

### CROSS-REFERENCE TO RELATED APPLICATIONS

This application is based on and claims priority under 35 USC 119 from Japanese Patent Application No. 2025-020934 filed February 12, 2025.

### BACKGROUND

### (i) Technical Field

The present disclosure relates to an authentication system, a cloud print service system, and a non-transitory computer readable medium.

### (ii) Related Art

In recent years, multi-factor authentication has often been introduced to enhance security. The "multi-factor authentication" is an authentication method for identity verification by combining two or more different authentication factors such as knowledge information, possession information, and biometric information. The knowledge information is information that is normally kept in memory, such as an ID and a password. The possession information is a user's property, such as an integrated circuit (IC) card, or information recorded in the property. The biometric information is physical information of a user, such as a fingerprint, face, or iris.

In Japanese Unexamined Patent Application Publication No. 2007-164643, when a user uses a device installed indoors, the user is requested to input an ID and a password for authentication. With an entry and exit management system in cooperation with the above-described authentication, if the user is authorized to enter a room by card authentication, an authentication result by this entry and exit management system is referred to so as to achieve multi-factor authentication.

Examples of the related art include Japanese Unexamined Patent Application Publication No. 2016-032926.

### SUMMARY

In a case where the multi-factor authentication is achieved with first authentication information used for authentication by the entry and exit management system and second authentication information used for authentication by an information processing apparatus installed in a space subjected to entry and exit management by the entry and exit management system, the first authentication information and the second authentication information are linked by the identification information of the same user. When a user succeeds in authentication using the second authentication information, a result of the user's authentication by the entry and exit management system is to be acquired for multi-factor authentication. Here, in some cases, the user's authentication is not successful, that is, the presence of the user in the space is not confirmed.

For example, it is assumed that the user has forgotten to carry an IC card for self-identification that is the first authentication information required to enter a space. In this case, the user may temporarily borrow a substitute IC card to enter the space. This lent IC card is different from the IC card for self-identification that is the first authentication information. Therefore, when the user uses the borrowed IC card, the user is actually present in a space, but his/her presence in the space is not confirmed due to the discordance of identification information.

Aspects of non-limiting embodiments of the present disclosure relate to achieving multi-factor authentication using the cooperated entry and exit management system even in a case where the authentication by the information processing apparatus installed in a space subjected to entry and exit management by the entry and exit management system is achieved but the presence of the user in the space is not confirmed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an authentication system including a processor configured to: perform, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and transmit code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.

### BRIEF DESCRIPTION OF THE DRAWINGS

Exemplary embodiments of the present disclosure will be described in detail based on the following figures, wherein:

FIG. 1 is a block diagram illustrating a configuration of a system including both an authentication system and a cloud print service system according to an exemplary embodiment;

FIG. 2 is a flowchart illustrating processing performed by a multifunction peripheral in multi-factor authentication according to the exemplary embodiment;

FIG. 3 is a flowchart illustrating processing performed by an entry and exit management server in multi-factor authentication according to the exemplary embodiment; and

FIG. 4 is a flowchart illustrating processing performed by an authentication server in multi-factor authentication according to the exemplary embodiment.

### DETAILED DESCRIPTION

Exemplary embodiments of the present disclosure will be described below with reference to the drawings.

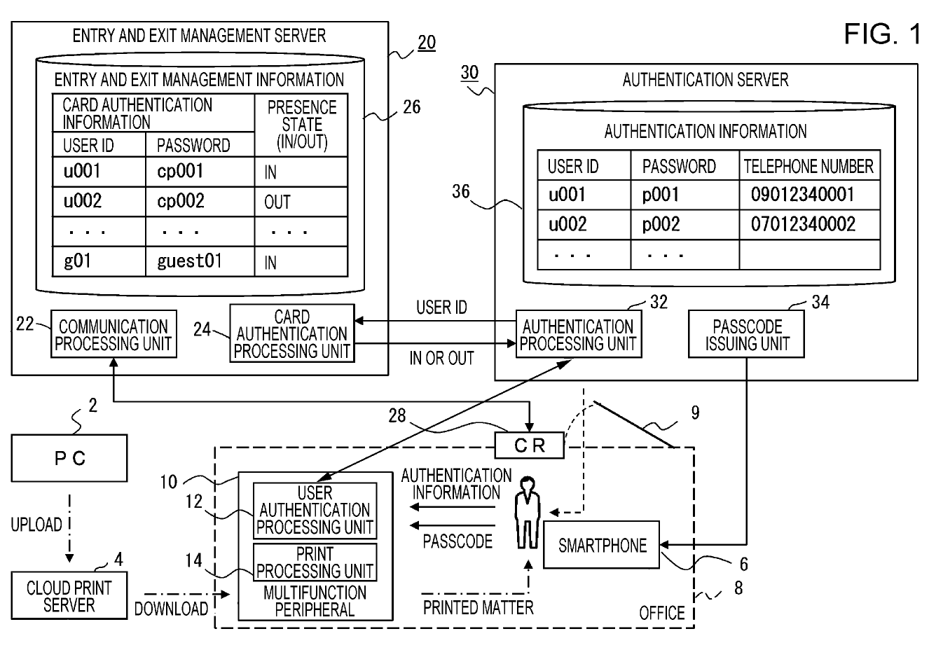

FIG. 1 is a block diagram illustrating a configuration of a system including both an authentication system and a cloud print service system according to an exemplary embodiment. FIG. 1 illustrates a personal computer (PC) 2, a cloud print server 4, a smartphone 6, a multifunction peripheral 10 installed in an office 8, an entry and exit management server 20, and an authentication server 30.

A cloud print service is provided using mainly the PC 2, the cloud print server 4, and the multifunction peripheral 10. The authentication system in the exemplary embodiment authenticates a user who uses the cloud print service. In particular, a user who is about to start using the multifunction peripheral 10 is subjected to authentication. The authentication system includes the authentication server 30, the multifunction peripheral 10, and the smartphone 6, and further cooperates with the entry and exit management server 20 in an entry and exit management system. The entry and exit management system manages entry to and exit from a building or a room or the like in the building. The exemplary embodiment uses a case of managing entry and exit of a user to and from a space referred to as the office 8 as an example.

A cloud print driver provided in the PC 2 allows the PC 2 to use the cloud print service. The PC 2 may be implemented by a general-purpose hardware configuration. That is, the PC 2 includes a central processing unit (CPU), a read only memory (ROM), a random access memory (RAM), a hard disk drive as a storage unit, a network interface provided as a communication unit, and a user interface including an input unit such as a mouse and a keyboard and a display unit such as a display.

The cloud print server 4 provides the cloud print service to a user of the PC 2 or the multifunction peripheral 10. The cloud print server 4 may be implemented by a hardware configuration of a general-purpose server computer. That is, the cloud print server 4 includes a CPU, a ROM, a RAM, a hard disk drive as a storage unit, and a network interface provided as a communication unit.

Print Agent installed in the multifunction peripheral 10 allows the multifunction peripheral 10 to use the cloud print service. The multifunction peripheral 10 is an image forming apparatus that has at least a printing function to serve as a printer. The multifunction peripheral 10 is an apparatus that has various functions such as a printing function, a copying function, and a scanner function, and includes therein an information processing apparatus. The multifunction peripheral 10 may be implemented by a hardware configuration of a general-purpose multifunction peripheral. That is, the multifunction peripheral 10 includes a CPU, a ROM, a RAM, a hard disk drive as a storage unit, a network interface provided as a communication unit, an operation panel as a user interface, a scanner, and a printer.

The multifunction peripheral 10 includes a user authentication processing unit 12 and a print processing unit 14. FIG. 1 omits components that are not used to describe the exemplary embodiment. The user authentication processing unit 12 performs authentication processing for a user who is about to use the multifunction peripheral 10. The print processing unit 14 performs printing. In the exemplary embodiment, the print processing unit 14 is able to perform printing using the cloud print service, that is, so-called cloud printing by Print Agent implementing a part of the functions of the print processing unit 14.

The following will briefly describe pull printing as an example of a flow of cloud printing processing provided by the cloud print service.

A user who uses the PC 2 uploads a print job to register the print job in the cloud print server 4. Thereafter, the user operates the multifunction peripheral 10 to display a list of print jobs that are registered in the cloud print server 4 but are unexecuted. The user needs to be authenticated in order to use the multifunction peripheral 10, and the user authentication will be described later.

When the user selects a print job from the list of print jobs, the print processing unit 14 requests the cloud print server 4 to transmit the selected print job. In response to the transmission request, the selected print job is downloaded from the cloud print server 4 to the multifunction peripheral 10. Then, the print processing unit 14 executes the downloaded print job. That is, the print processing unit 14 performs cloud printing.

The contents of the cloud print service itself may be the same as those in the related art.

The smartphone 6 is an example of a mobile terminal carried by a user. The smartphone 6 may also be a conventional general-purpose device. In the exemplary embodiment, the smartphone 6 is used for authentication in the office 8. It is assumed that basically the same person uses the PC 2 and the smartphone 6. While the smartphone 6 is carried by the user as described above, the installation location or use location of the PC 2 is not particularly limited.

The entry and exit management system in the exemplary embodiment manages the entry and exit of users to and from the office 8. Similarly to the cloud print server 4, the entry and exit management server 20 in the entry and exit management system may be implemented by a hardware configuration of a general-purpose server computer.

The entry and exit management server 20 includes a communication processing unit 22, a card authentication processing unit 24, and a storage unit 26 that stores entry and exit management information. The communication processing unit 22 is connected with a cable or wirelessly to a card reader (CR) 28 installed at the doorway of a space subjected to entry and exit management, that is, the office 8 in the exemplary embodiment. The card authentication processing unit 24 performs user authentication on the basis of card authentication information read out from an IC card (not illustrated) by the card reader 28.

In the entry and exit management information, the card authentication information of a user who is subjected to entry and exit management and the presence state of the user are set in an associated manner. The card authentication information is first authentication information used for authentication in the entry and exit management system. In the card authentication information, a user ID as user identification information and a password are set as a pair. The exemplary embodiment describes, as an example, a case where a user ID is used as a card ID, which is information unique to a card, for the sake of convenience. However, if a card ID and a user ID are generated as different identification codes, both the user ID and the card ID are set in the card authentication information. The user ID is required to be linked with a user ID for identifying a user in the authentication system.

The presence state is set to either "in" or "out". The "in" indicates a state where the user is in the office 8, that is, a so-called "present" state. The "out" indicates a state where the user has left the office 8 and is thus not present in the office 8.

A user who enters or leaves the office 8 basically has an IC card. However, it is troublesome if a user who is normally allowed to enter the office 8 cannot enter because the user forgets to carry his/her IC card. Thus, an IC card for lending (hereinafter referred to as a "guest card") is prepared to allow the user to temporarily enter the office 8. A guest card is also prepared to allow an actual guest to enter the office 8. The entry and exit of a user using this guest card is also managed by the entry and exit management information.

The exemplary embodiment focuses on entry and exit at the office 8 for the sake of convenience of description. However, if the entry and exit of users at a plurality of spaces is managed, it is necessary to manage the entry and exit management information in such a way that the presence state is linked with each user and with each space. In addition, the authority for entry and exit may be set for each user and for each space, and in this case, the authority information also needs to be linked.

The following will describe the entry and exit management performed by the entry and exit management server 20. A door 9 provided in a space such as the office 8 subjected to entry and exit management is normally locked.

When a user moves within a building, the user always carries his/her IC card. In the IC card, the authentication information of a user who carries the card, that is, a user ID as user identification information in the exemplary embodiment, is recorded. When a user who is about to enter or leave the office 8 holds the IC card over the card reader 28, the card reader 28 reads the authentication information from the IC card and transmits the authentication information to the communication processing unit 22. While holding the IC card over the card reader 28, the user may be requested to input a password through an operation button (not illustrated). Alternatively, the password may be recorded on the IC card.

The card authentication processing unit 24 collates the authentication information received through the communication processing unit 22 with the card authentication information registered in the entry and exit management information. When the card authentication information that matches the authentication information recorded in the IC card is present, as a result of the collation, the user authentication is considered to be successful, so that the card authentication processing unit 24 instructs a door opening/closing mechanism (not illustrated) to unlock the door 9. Consequently, the user is able to enter the office 8. Here, the card authentication processing unit 24 changes the setting of the presence state linked with the user from "out" to "in" in the entry and exit management information. On the other hand, when the card authentication information that matches the authentication information recorded in the IC card is absent, as a result of the collation, the user authentication is considered to be unsuccessful, so that the card authentication processing unit 24 does not give any instruction to the door opening/closing mechanism. Alternatively, the card authentication processing unit 24 may instruct the door opening/closing mechanism to maintain the locked state of the door 9.

The contents of the entry and exit management may be basically the same as those in the related art. The exemplary embodiment is different in that the card authentication processing unit 24 responds with the entry/exit state of a user in response to an inquiry from the authentication server 30.

The authentication system authenticates a user who is about to start using the multifunction peripheral 10 installed in the office 8. In the authentication system of the exemplary embodiment, the authentication server 30 operates in cooperation with the multifunction peripheral 10 and the entry and exit management server 20 so as to achieve multi-factor authentication.

Similarly to the cloud print server 4 and the entry and exit management server 20, the authentication server 30 may be implemented by a hardware configuration of a general-purpose server computer. The authentication server 30 includes an authentication processing unit 32, a passcode issuing unit 34, and a storage unit 36 for authentication information. The authentication processing unit 32 performs multi-factor authentication processing, which will be described in detail later. The passcode issuing unit 34 issues a passcode as code information in response to an instruction from the authentication processing unit 32.

The authentication information is second authentication information used for user authentication by the multifunction peripheral 10. The second authentication information for one user needs to be different from the first authentication information used by the entry and exit management system in order to achieve multi-factor authentication. In the authentication information, a user ID as identification information of a user of the multifunction peripheral 10 and a password are set as a pair. Furthermore, as contact information of each user, the telephone number of the smartphone 6 that the user owns and normally carries is set in association with the user ID.

The exemplary embodiment focuses on the single multifunction peripheral 10 installed in the office 8. However, if user authentication is performed for a plurality of multifunction peripherals 10, it is necessary to manage authentication information in association with each multifunction peripheral. For example, the authentication information is linked with a device ID of the multifunction peripheral. Further, the use authority for each user may be set for each multifunction peripheral.

The multifunction peripheral 10 requests user authentication by transmitting the authentication information input by a user through the operation panel to the authentication server 30. While the multifunction peripheral 10 has a single-factor authentication function based on this authentication information, the authentication server 30 of the exemplary embodiment separately performs user authentication in cooperation with the entry and exit management system, in addition to the user authentication based on the authentication information transmitted from the multifunction peripheral 10, so as to achieve multi-factor authentication.

The following will describe an operation of the exemplary embodiment. It is assumed here that a user has already uploaded a print job through the PC 2 and the print job is registered in the cloud print server 4. It is also assumed that the user outside the office 8 is about to execute the registered print job by operating the multifunction peripheral 10.

Here, the user is supposed to hold the IC card he/she carries over the card reader 28 to enter the office 8. As described above, the authentication information read from the IC card by the card reader 28 is transmitted to the entry and exit management server 20, so that the card authentication processing unit 24 performs user authentication. The following description will continue on the assumption that the entry has been successful and the presence state of the user is changed to "in". However, it is unknown at this time whether the IC card is exclusive for this user or is a guest card.

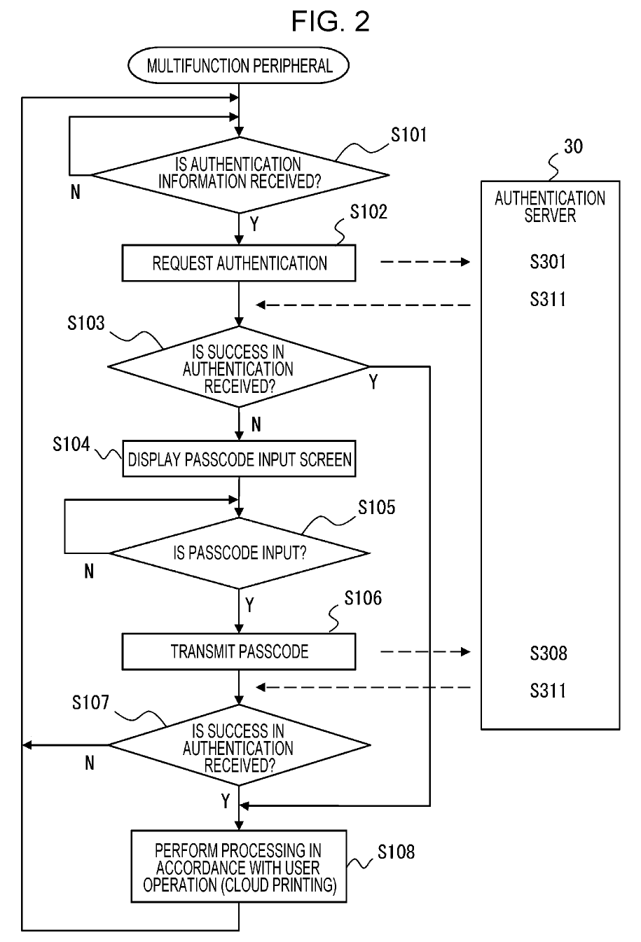

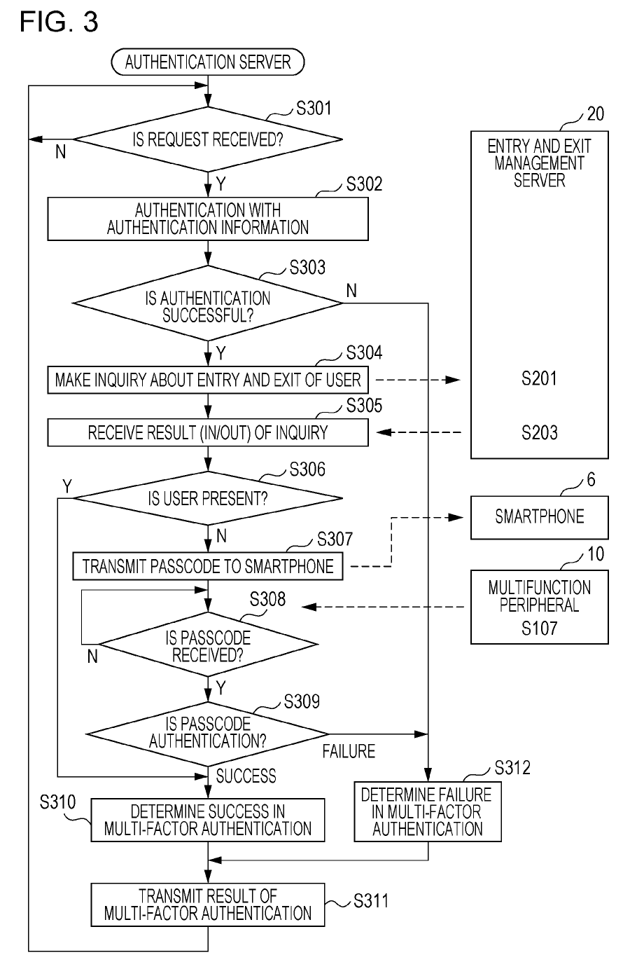

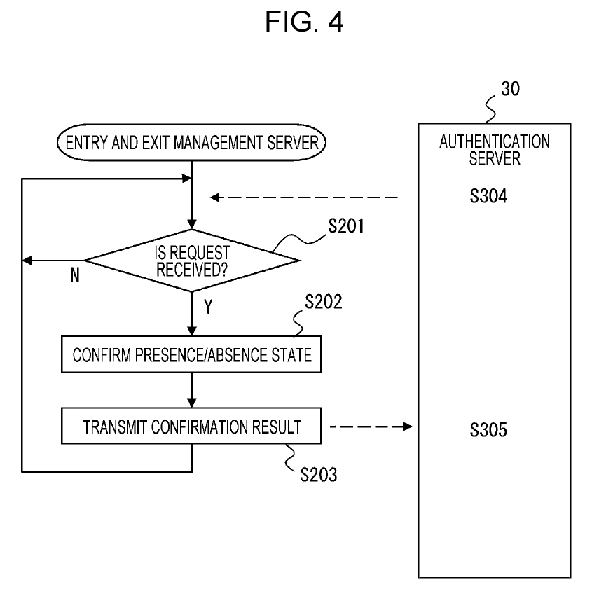

While the multi-factor authentication is performed in the exemplary embodiment as described above, the processing performed for the multi-factor authentication will be described below with reference to flowcharts illustrated in FIGS. 2 to 4. FIG. 2 is a flowchart illustrating processing in the multifunction peripheral 10, FIG. 3 is a flowchart illustrating processing in the authentication server 30, and FIG. 4 is a flowchart illustrating processing in the entry and exit management server 20.

When the multifunction peripheral 10 is in an unused state, the multifunction peripheral 10 waits for user login, that is, waits to receive input of authentication information (N at step S101). After entering the office 8, a user inputs a user ID and a password as authentication information by operating the operation panel of the multifunction peripheral 10, for example. When the multifunction peripheral 10 receives the authentication information (Y at step S101), the user authentication processing unit 12 transmits the received authentication information to the authentication server 30 so as to request user authentication (step S102).

The authentication server 30 normally waits for a request for user authentication, that is, waits to receive authentication information (N at step S301). Having received the authentication information transmitted from the multifunction peripheral 10 (Y at step S301), the authentication processing unit 32 performs authentication by collating the received authentication information with the authentication information registered in the storage unit 36 (step S302).

When the authentication based on the authentication information is not successful (N at step S303), the authentication processing unit 32 determines a failure in authentication (step S312), and transmits the determination result, that is, the multi-factor authentication result indicating an authentication failure, to the multifunction peripheral 10 (step S311).

On the other hand, when the authentication based on the authentication information is successful (Y at step S303), the authentication processing unit 32 checks the entry/exit state of the user by inquiring of the entry and exit management server 20 with the user ID included in the authentication information (step S304).

In the entry and exit management server 20, the card authentication processing unit 24 waits to receive an authentication request (N at step S201). Here, having received the inquiry about entry/exit state confirmation from the authentication server 30 (Y at step S201), the card authentication processing unit 24 collates the user ID included in the inquiry with the card authentication information registered in the storage unit 26, and confirms the presence state of the user (step S202). Then, the card authentication processing unit 24 transmits the confirmed result to the authentication server 30 (step S203).

The authentication processing unit 32 of the authentication server 30 receives the entry/exit state of the user as an inquiry result from the entry and exit management server 20 (step S305).

As described above, the user who has succeeded in authentication by the multifunction peripheral 10 is able to enter the office 8, while it is unknown whether the IC card used to enter the office 8 is exclusive for this user or is a guest card. If the user has entered the office 8 using his/her IC card, the presence state of the user can be confirmed as "in", that is, "present". For example, if a user with a user ID "u001" is permitted to enter the office 8 using his/her IC card, the presence state of the user in the entry and exit management information should be set to "in".

On the other hand, if the user with the user ID "u001" has forgotten his/her IC card and temporarily entered the office 8 using a borrowed IC card with a user ID "g01", that is, a so-called guest card, the presence state of the user with the user ID "g01" is "in", but the presence state of the user with the user ID "u001" remains set to "out".

In other words, in a case where the user with the user ID "u001" (hereinafter also referred to as "user u001") has entered the office 8 using his/her IC card, the presence state of the user u001 is "in", that is, the user is present (Y at step S306). Thus, the authentication processing unit 32 determines that the user authentication using the IC card in the entry and exit management system is successful. As described above, the user authentication based on the authentication information transmitted from the multifunction peripheral 10 is already successful. Therefore, the authentication processing unit 32 determines a success in multi-factor authentication on the basis of both of the determination results (step S310), and transmits the determination result, that is, the result indicating the success in multi-factor authentication, to the multifunction peripheral 10 (step S311).

On the other hand, in a case where the user u001 has entered the office 8 using the guest card with the user ID "g01", the presence state of the user u001 remains "out". Therefore, it is determined that the user u001 is not present. As described above, in a case where the authentication using the authentication information from the multifunction peripheral 10 is successful but the presence of the user u001 in the office 8 is not confirmed on the basis of the authentication result by the entry and exit management system (N at step S306), the authentication processing unit 32 specifies the user u001 as an authentication target and instructs the passcode issuing unit 34 to issue a passcode. In response to this instruction, the passcode issuing unit 34 issues a passcode, and transmits the passcode in the form of a short message using a short message service (SMS) to a transmission destination specified by the telephone number linked with the user u001 (step S307). As described above, this telephone number is linked with the smartphone 6 of the user u001. Thus, the passcode reaches the smartphone 6 carried by the user u001. The authentication server 30 links the transmitted passcode with the user ID "u001" of the user who is a transmission destination, and stores the passcode therein.

After requesting authentication (step S102), the multifunction peripheral 10 waits to receive an authentication result. In this reception waiting state, the multifunction peripheral 10 waits for a result of the processing at step S311 by the authentication server 30, that is, the multi-factor authentication. Since the multifunction peripheral 10 requests single-factor authentication using authentication information, the multifunction peripheral 10 does not need to recognize multi-factor authentication.

Having received a notification indicating a success in authentication from the authentication server 30 (Y at step S103), the multifunction peripheral 10 allows the user to start using the multifunction peripheral 10. Consequently, the user is able to cause the multifunction peripheral 10 to perform desired processing by operating the operation panel. In other words, the multifunction peripheral 10 performs the instructed processing in accordance with the user operation (step S108). For example, when the operation of cloud printing is started, the print processing unit 14 displays a list of print jobs that are registered in the cloud print server 4 by the user but are unexecuted. When the user specifies a desired print job from the list, the print processing unit 14 downloads and acquires the specified print job from the cloud print server 4, and executes the print job. In this manner, the user is able to acquire a printed matter that is an execution result of the print job.

On the other hand, having received a notification indicating a failure in authentication from the authentication server 30 (N at step S103), the user authentication processing unit 12 displays a predetermined passcode input screen on the operation panel (step S104).

The user u001 who has entered the office 8 using the guest card carries the smartphone 6 also in the office 8. Therefore, the passcode transmitted at step S307 is displayed on the smartphone 6 immediately after the reception of the email, which allows the user to check the passcode immediately after the reception of the email. The user is supposed to be in front of the multifunction peripheral 10 from the time of inputting authentication information into the multifunction peripheral 10. Thus, having noticed the passcode input screen displayed on the operation panel of the multifunction peripheral 10, the user inputs the passcode displayed on the touch panel of the smartphone 6 in hand into a predetermined input area of the passcode input screen.

After displaying the passcode input screen, the multifunction peripheral 10 waits to receive the input of a passcode (N at step S105). Then, when the user inputs a passcode as described above, the user authentication processing unit 12 receives the passcode (Y at step S105), links the input passcode with the user ID "u001" of the user to be authenticated, and transmits the passcode to the authentication server 30 (step S106).

After transmitting the passcode to the smartphone 6, the authentication server 30 waits to receive a passcode transmitted from a predetermined apparatus (N at step S308).

In the exemplary embodiment, since the multifunction peripheral 10 having an operation panel is used as a printer, a user is able to input a passcode through the multifunction peripheral 10. If a printer does not have an input unit, a user may input a passcode through another device as the predetermined apparatus, such as the smartphone 6 or a PC in the office 8, and transmit the passcode to the authentication server 30. In this case, the authentication server 30 receives the passcode input by the user through the smartphone 6 or the like.

When the authentication server 30 receives the passcode transmitted from the multifunction peripheral 10, the authentication processing unit 32 performs authentication using the passcode by collating the received pair of user ID and passcode with the pairs of user IDs and passcodes stored in the authentication server 30. When the authentication using the passcode is also unsuccessful (failure at step S309), the authentication processing unit 32 determines a failure in authentication (step S312), and transmits the determination result, that is, the multi-factor authentication result indicating authentication failure, to the multifunction peripheral 10 (step S311).

On the other hand, when the authentication using the passcode is successful (success at step S309), the authentication processing unit 32 determines a success in multi-factor authentication (step S310), and transmits the determination result, that is, the result indicating a success in multi-factor authentication, to the multifunction peripheral 10 (step S311).

After transmitting the passcode, the multifunction peripheral 10 waits to receive an authentication result. Here, having received a notification indicating a success in authentication from the authentication server 30 (Y at step S107), the multifunction peripheral 10 allows the user to start using the multifunction peripheral 10. Consequently, the user is able to cause the multifunction peripheral 10 to perform desired processing by operating the operation panel. In other words, the multifunction peripheral 10 performs the instructed processing in accordance with the user operation (step S108).

On the other hand, when a notification indicating a failure in authentication is received from the authentication server 30 (N at step S107), it is considered that the user authentication is unsuccessful even if the user uses a passcode, and the multifunction peripheral 10 proceeds to step S101 in order to respond to the next authentication request. The user authentication processing unit 12 may display, on the operation panel, information indicating that the user authentication is eventually unsuccessful.

As described above, in the exemplary embodiment, even in a case where a user to be authenticated has entered the office 8 using, for example, a guest card instead of an IC card exclusive for him/her and thus the presence of the user in the office 8 is not confirmed, it is possible to achieve multi-factor authentication with the use of code information separately issued by the authentication server 30.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is also applicable to a program and a program product.

### Appendix

(((1)))

An authentication system comprising:

a processor configured to:

perform, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and

transmit code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.

(((2)))

The authentication system according to (((1))), wherein the processor is configured to:

receive information transmitted from a predetermined apparatus in response to transmission of the code information; and

confirm that the user succeeds in multi-factor authentication when the received information matches the code information transmitted to the transmission destination.

(((3)))

The authentication system according to (((2))), wherein the predetermined apparatus is the information processing apparatus that transmits the second authentication information.

(((4)))

The authentication system according to (((2))), wherein

the transmission destination and the predetermined apparatus are a mobile terminal carried by the user, and

the processor is configured to receive information input by the user through the mobile terminal.

(((5)))

A cloud print service system comprising:

the authentication system according to any one of (((1))) to (((4)));

a server configured to provide a cloud print service; and

a printer configured to execute a print job for a user of the cloud print service and serve as the information processing apparatus.

(((6)))

A program causing a computer to execute a process comprising:

performing, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and

transmitting code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.

What is claimed is:

1. An authentication system comprising:
a processor configured to:
perform, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and
transmit code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.

2. The authentication system according to claim 1, wherein the processor is configured to:
receive information transmitted from a predetermined apparatus in response to transmission of the code information; and
confirm that the user succeeds in multi-factor authentication when the received information matches the code information transmitted to the transmission destination.

3. The authentication system according to claim 2, wherein the predetermined apparatus is the information processing apparatus that transmits the second authentication information.

4. The authentication system according to claim 2, wherein
the transmission destination and the predetermined apparatus are a mobile terminal carried by the user, and
the processor is configured to receive information input by the user through the mobile terminal.

5. A cloud print service system comprising:
the authentication system according to claim 1;
a server configured to provide a cloud print service; and
a printer configured to execute a print job for a user of the cloud print service and serve as the information processing apparatus.

6. A cloud print service system comprising:
the authentication system according to claim 2;
a server configured to provide a cloud print service; and
a printer configured to execute a print job for a user of the cloud print service and serve as the information processing apparatus.

7. A cloud print service system comprising:
the authentication system according to claim 3;
a server configured to provide a cloud print service; and
a printer configured to execute a print job for a user of the cloud print service and serve as the information processing apparatus.

8. A cloud print service system comprising:
the authentication system according to claim 4;
a server configured to provide a cloud print service; and
a printer configured to execute a print job for a user of the cloud print service and serve as the information processing apparatus.

9. A non-transitory computer readable medium storing a program causing a computer to execute a process comprising:
performing, upon receiving, from an information processing apparatus, second authentication information that is used for authentication of a user by the information processing apparatus installed in a space subjected to entry and exit management by an entry and exit management system that performs authentication using first authentication information and that is different from the first authentication information, multi-factor authentication using an authentication result obtained by the entry and exit management system in addition to the authentication using the second authentication information; and
transmitting code information to a transmission destination linked with the user, when the authentication using the second authentication information is successful but presence of the user in the space is not confirmed based on the authentication result obtained by the entry and exit management system, so as to perform multi-factor authentication using the second authentication information and the code information.
